(19) United States
(12) Patent Application Publication
(10) Pub. No.: US 2012/0318970 A1
(43) Pub. Date: Dec. 20, 2012

(54) ION SELECTION OPTIMIZATION FOR MASS SPECTROMETRY

(76) Inventors: Bruce D. Quimby, Lincoln University, PA (US); Michael J. Szelewski, Hockessin, DE (US)

(21) Appl. No.: 13/160,714

(22) Filed: Jun. 15, 2011

(51) Int. Cl. H01J 49/00; H01J 49/26

(52) U.S. Cl. 250/282; 250/288

(57) ABSTRACT

Systems and methods for mass spectrometry are presented. In one embodiment, a method for selecting a target ion and a plurality of qualifier ions for calibration of an analyte in an MS test is presented. For example, the method may include: (a) obtaining a reference spectrum for the analyte; (b) identifying an extraction time window for the reference spectrum; (c) extracting a matrix spectrum over the extraction time window; (d) measuring a noise value in a plurality of matrix ions; (e) calculating a signal-to-noise value for a plurality of analyte ions by dividing the abundance of the analyte ion by the noise value at a corresponding matrix ion; (f) assigning the target ion as the analyte ion having the highest signal-to-noise value; and (g) assigning a qualifier ion as the analyte ion with the next highest signal-to-noise value.

### SUMMARY

Presented herein are systems and methods for selecting a target ion and a plurality of qualifier ions for calibration of an analyte in an MS test. In one embodiment, for example, the method may include: (a) obtaining a reference spectrum for the analyte; (b) identifying an extraction time window for the reference spectrum; (c) extracting a matrix spectrum over the extraction time window; (d) measuring a noise value in a plurality of matrix ions; (e) calculating a signal-to-noise value for a plurality of analyte ions by dividing the abundance of the analyte ion by the noise value at a corresponding matrix ion; (f) assigning the target ion as the analyte ion having the highest signal-to-noise value; and (g) assigning a qualifier ion as the analyte ion with the next highest signal-to-noise value.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 shows a library reference spectrum of cocaine and interference spectrum of arachidonic acid.

FIG. 2 shows expanded regions of the spectra of FIG. 1 to illustrate the interference problems.

FIG. 3 shows the information of FIG. 2 in tabular form.

FIG. 4 shows how the choice of cocaine ions is affected by the minimum ion abundance parameter.

FIG. 5 shows the effect of using high mass bias.

FIG. 6 shows the effect of using different minimum abundance cut off levels.

FIG. 7 shows a sample where the arachidonic acid is still at 2000 ng, but the cocaine is now tenfold lower at 0.1 ng.

FIG. 8 shows a reference spectrum of heroin and average spectrum of background and column bleed.

FIG. 9 shows a comparison the of biggest four ions and opt 25% results for heroin optimized against column bleed.

FIG. 10 is a schematic drawing of a computer system used to implement the methods presented herein.

### DETAILED DESCRIPTION

The present invention generally relates to mass spectral (MS) analysis. More specifically, the present invention relates to systems and methods for selecting a target ion and a plurality of qualifier ions for calibration of a specific analyte in an MS test.

The invention provides a very rapid, reliable means of choosing the optimal ions for a given list of analytes. Without the invention, the manual task of choosing optimal ions is extremely large, tedious, and potentially inaccurate.

For example, analytes are typically identified and quantitated in gas chromatography-mass spectrometry (GC/MS) by generating extracted ion chromatograms (EICs) for a target ion and up to three qualifier ions over the time range of elution of the analyte from the column. The compound is deemed present and confirmed if: 1) there is a chromatographic response at the target and qualifier ions at the correct retention time for the analyte; 2) the relative size of the responses at the qualifier ions compared to the response at the target ion falls within a range determined by calibration with a known standard(s) of the analyte, if the responses are at the correct retention time and in the correct response ratios, the compound is deemed present (i.e., identified); 3) identity of the compound may optionally be further confirmed by comparison of the full spectrum at the retention time of the compound with a library reference spectrum to see if they match; and 4) for a compound deemed identified, it is usually then quantitated. This process is typically done by comparing the response at the target ion with a calibration curve of response versus amount injected for the compound. The calibration curve is generated by injecting a series of standard solutions of the analyte at various known concentrations. This approach is widely used in all forms of chromatography interfaced to mass spectrometry for performing analyses. It is used for data collected in full scan or single ion monitoring (SIM) mode.

With samples for which there are no interfering compounds that elute from the GC column at the retention time of a specific analyte, the above approach works very well. Problems occur, however, when other compounds (interferences) elute close enough to an analyte that their chromatographic profiles overlap. Problems also occur when the interfering compounds have ions at one or more of the same m/z values as the target and qualifier ions for the analyte.

Interferences can result from several sources, but most commonly are compounds that are naturally occurring in the sample matrix being analyzed. For example, in the analysis of pesticide residues in fresh spinach, there are large numbers of naturally occurring compounds from the spinach plant that are extracted along with the pesticides during sample preparation for analysis. These matrix compounds interfere with the detection of some of the pesticides that are being analyzed.

Provided herein is a method for selecting a target ion and a plurality of qualifier ions for calibration of an analyte in an MS test. The method generally includes: (a) obtaining a reference spectrum for the analyte; (b) identifying an extraction time window for the reference spectrum; (c) extracting a matrix spectrum over the extraction time window; (d) measuring a noise value in a plurality of matrix ions; (e) calculating a signal-to-noise value for a plurality of analyte ions by dividing the abundance of the analyte ion by the noise value at a corresponding matrix ion; (f) assigning the target ion as the analyte ion having the highest signal-to-noise value; and (g) assigning a qualifier ion as the analyte ion with the next highest signal-to-noise value. Step (g) may be repeated (e.g., until three qualifier ions are selected). Step (e) may further comprise calculating a signal-to-noise value for a plurality of analyte ions by dividing the abundance of the analyte ion by the noise value at a corresponding matrix ion, and multiplying by a square root of the abundance of the matrix ion. Step (a) may further comprise processing the reference spectrum to remove ions that are below a user-specified minimum abundance. The minimum abundance may be twenty-five percent. Step (a) may further comprise processing the reference spectrum to remove ions that are below a user-specified mass minimum. The mass minimum abundance is 45 amu. Such steps may be used in a mass spectrometry method comprising selecting a target ion and three qualifier ions, for calibration of an analyte in an MS test.

In another embodiment, provided herein are systems and processes for ion selection for use by GC/MS method developers. The systems and processes choose the four ions (target and up to three qualifiers) that are used in a quantitation database (qdb) for quantitation and identity confirmation. The ions are chosen based on abundance, degree of interference, and mass. By selection of the appropriate ions, the method detection limits can be improved, and the occurrence of both false positives and negatives can be reduced. If the qdb ions have already been chosen, the systems and processes can be used to evaluate those ions for matrix interferences when a new sample type is to be analyzed.

The choice of ions for use in the qdb is a very important part of method development in GC/MS. If the wrong ions are chosen, interferences can cause problems with the identification and quantitative measurement of analytes. Ions with the highest abundance are often chosen because they give the maximum sensitivity. Ions are also chosen that are the least affected by interference to give maximum selectivity over matrix. These two requirements often lead to conflicting choices.

The simplest approach to choosing ions is to take the four ions with the largest abundances. While this works in many cases, there can be problems with those ions if they correspond to background components like column bleed, atmospheric gases (leaks), or matrix components. To properly choose ions for the qdb, the spectrum of the analyte is inspected and compared to the spectra of the matrix, column bleed, and any other background ions that may be present. Ions are then selected that have the best combination of sensitivity and freedom from interference.

The systems and processes discussed herein provide an automated ion selection means by using parameters entered by a user that reflect preferences based on expected sample types to be run. The user starts by loading the method to be optimized in a data analysis session. The loaded method must have the analytes entered as calibration peaks (calpeak) in the quantitation database. The calpeak should have a reference spectrum in the method reference spectral library (.L) located in the database directory. The user then loads a datafile run with the method that is either a blank, or a sample of matrix that is free (or almost free) of analytes. If the datafile is that of a blank run, the macro can optimize the ions to minimize interference from background ions and bleed. If the datafile is a sample of matrix (free of analytes), then the ions can be chosen to minimize interference from background ions, bleed, and matrix compounds. Once the method and datafile are loaded, the user may be asked to input relevant parameters for the optimization. These include the minimum abundance and mass that are acceptable for an ion to be chosen.

### Optimization Process

The optimization process for an individual calpeak is as follows:

1. The reference spectrum for the calpeak is fetched from the .L library.
2. A copy of the reference spectrum is made using only analyte ions that are greater than the user specified minimum abundance for optimization (e.g., 25%) and greater than the mass minimum (e.g., 45 amu). These are the ions eligible to participate in optimization. The spectrum is normalized to 10,000.
3. The ion chromatogram (EIC) for each eligible m/z is extracted from the matrix datafile over the calpeak extraction time window. The noise of the EIC is measured. The abundance (abd) of each eligible analyte ion is divided by the matrix noise at that m/z to get a signal-to-noise (S/N) value. As an option, the S/N value is further multiplied by the square root of the m/z, which gives preference to high mass ions.
4. Candidate ions are sorted highest to lowest S/N value and the top four are used for Target (T), First Qualifier Ion (Q1), Second Qualifier Ion (Q2), and Third Qualifier Ion (Q3) in descending order, which places the ion with the best S/N value as the target. Ions with the best S/N value are also the most selective over matrix.
5. If there are four eligible S/N value sorted ions, these are used to replace those in qdb.
6. The optimized ions are loaded into qdb, along with a new estimated response. The estimated response is calculated by multiplying the old response by the abd of the new target divided by that of the old target ion. This new response will be replaced when the new method is recalibrated, but the estimate may be useful for screening methods where recalibration will not be done immediately.
7. If there are less than four eligible S/N value sorted ions, the remainder are taken from the original four qdb ions. Ions taken from the original four are chosen to be above the mass cutoff and a user specified minimum abd for Q3. If no ions in the original four meet these criteria, then whatever is available is used for Q2, and Q3 is left empty.
8. In those cases where optimization is not possible (e.g., less than two eligible ions), the four original qdb ions are inspected and Q3 is removed if it is less than the mass cutoff or the user specified minimum abd for Q3.

Because the invention chooses optimal ions for a method so rapidly, it is possible to have a separate set of ions chosen for each matrix type. For example, a lab running large pesticide screening methods can have separate methods optimized for spinach, carrots, apples, etc., which is not practical without the invention.

The above description refers to using the invention for GC/MS, but the process would be the same with other forms of chromatography/MS. For GC/MS/MS, the optimal ions chosen can be used as precursor ions in method development. A subsequent step would then be to choose the appropriate product ions and collision voltages to complete the GC/MS/MS method.

### General Guidelines for Parameter Selection

The first consideration for parameter selection is the type of matrix expected for the method being optimized. If the samples are expected to have high levels of matrix and the types of matrix compounds (but not necessarily their amounts) are fairly consistent, then use of a low abundance minimum for optimization can be very beneficial as seen in the cocaine example below. An optimization minimum abundance level of 10% is a good place to start. This should provide good rejection of the interference compounds. At this cut off level, however, the ions chosen can have fairly low abundances and would give less than the optimal S/N value if some samples in the batch have no matrix interferences. It is desirable to tune against a medium level of the expected interferences. It is also possible to create a separate method optimized at a lower cut off to re-analyze the data if a particularly dirty sample is encountered.

In an application like the analysis of pesticides in orange oil, the interferences are severe but fairly consistent. As such, it may be useful to reduce the cut off to a very low level (e.g., 3%).

For samples where the matrix is expected to be relatively low and widely varying, it is better to use a 25% cutoff and apply the high mass bias. In this case, the optimization would just be done against a blank run. If there is any chance of the solvent tailing into the time range of the analytes, it would be good do include the solvent in the blank as well.

Different analysts have varying preferences when it comes to the minimum mass cutoff. Mass 45 is a good place to start. As with the abundance cut off, in situations like the orange oil above, having no mass cut off may be beneficial in finding useful ions.

Since it may be difficult to find a single analyte free matrix chromatogram to represent all the interferences that may be encountered by a method, the process may optimize against multiple chromatograms simultaneously. Up to five chromatograms can be used. Each ion is optimized using the average signal to noise ratio from the five chromatograms. This approach slows the calculation time, but may be beneficial in reducing the effect of variability in matrix interferences. If, for example, a method is being constructed for pesticides in strawberries, using matrix blank runs from several different types of strawberries would be desirable. For reference, the calculation time against a single chromatogram is roughly 0.25 second per calibration peak at 25% cutoff. For a qdb with 600 compounds, optimization against five chromatograms might take 5 min or more of calculation time.

### Computer Implementation.

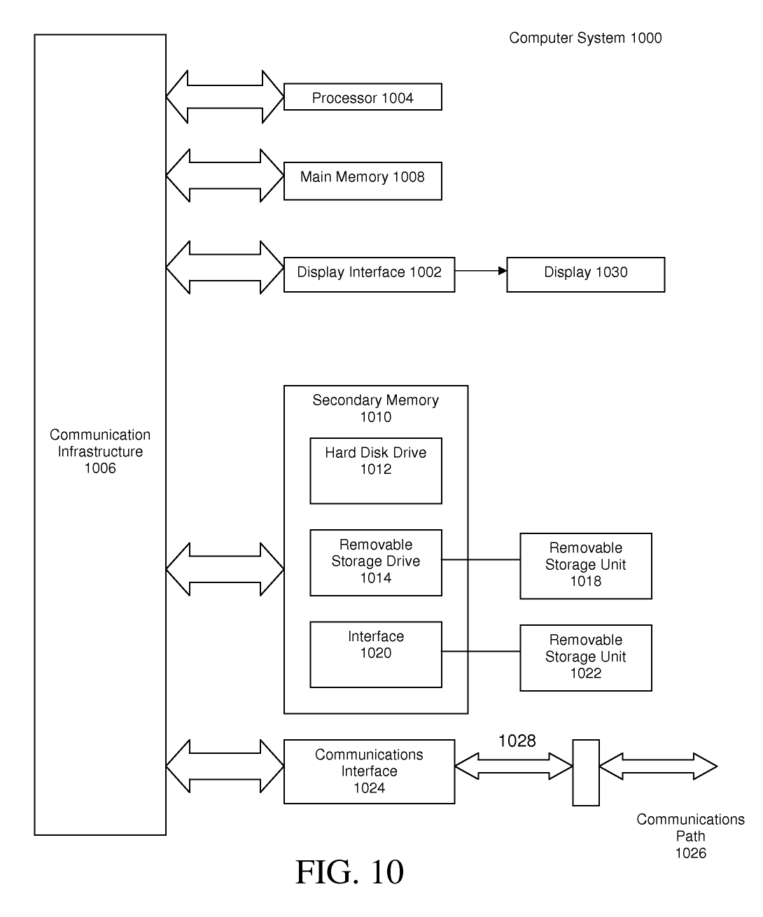

In one embodiment, the invention is directed toward one or more computer systems capable of carrying out the functionality described herein. For example, FIG. 10 is a schematic drawing of a computer system 1000 used to implement the methods presented herein. Computer system 1000 includes one or more processors, such as processor 1004. The processor 1004 is connected to a communication infrastructure 1006 (e.g., a communications bus, cross-over bar, or network). Computer system 1000 can include a display interface 1002 that forwards graphics, text, and other data from the communication infrastructure 1006 (or from a frame buffer not shown) for display on a local or remote display unit 1030.

Computer system 1000 also includes a main memory 1008, such as random access memory (RAM), and may also include a secondary memory 1010. The secondary memory 1010 may include, for example, a hard disk drive 1012 and/or a removable storage drive 1014, representing a floppy disk drive, a magnetic tape drive, an optical disk drive, flash memory device, etc. The removable storage drive 1014 reads from and/or writes to a removable storage unit 1018. Removable storage unit 1018 represents a floppy disk, magnetic tape, optical disk, flash memory device, etc., which is read by and written to by removable storage drive 1014. As will be appreciated, the removable storage unit 1018 includes a computer usable storage medium having stored therein computer software, instructions, and/or data.

In alternative embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow computer software, instructions, and/or data to be transferred from the removable storage unit 1022 to computer system 1000.

Computer system 1000 may also include a communications interface 1024. Communications interface 1024 allows computer software, instructions, and/or data to be transferred between computer system 1000 and external devices. Examples of communications interface 1024 may include a modem, a network interface (such as an Ethernet card), a communications port, a Personal Computer Memory Card International Association (PCMCIA) slot and card, etc. Software and data transferred via communications interface 1024 are in the form of signals 1028 which may be electronic, electromagnetic, optical or other signals capable of being received by communications interface 1024. These signals 1028 are provided to communications interface 1024 via a communications path (e.g., channel) 1026. This channel 1026 carries signals 1028 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 1014, removable storage units 1018, 1022, data transmitted via communications interface 1024, and/or a hard disk installed in hard disk drive 1012. These computer program products provide computer software, instructions, and/or data to computer system 1000. Embodiments of the present invention are directed to such computer program products.

Computer programs (also referred to as computer control logic) are stored in main memory 1008 and/or secondary memory 1010. Computer programs may also be received via communications interface 1024. Such computer programs, when executed, enable the computer system 1000 to perform the features of the present invention, as discussed herein. In particular, the computer programs, when executed, enable the processor 1004 to perform the features of the presented methods. Accordingly, such computer programs represent controllers of the computer system 1000. Where appropriate, the processor 1004, associated components, and equivalent systems and sub-systems thus serve as “means for” performing selected operations and functions.

In an embodiment where the invention is implemented using software, the software may be stored in a computer program product and loaded into computer system 1000 using removable storage drive 1014, interface 1020, hard drive 1012, or communications interface 1024. The control logic (software), when executed by the processor 1004, causes the processor 1004 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium for selecting a target ion and a plurality of qualifier ions for calibration of an analyte in an MS test, comprising instructions executable by at least one processing device that, when executed, cause the processing device to: (a) obtain a reference spectrum for the analyte; (b) identify an extraction time window for the reference spectrum; (c) extract a matrix spectrum over the extraction time window; (d) measure a noise value in a plurality of matrix ions; (e) calculate a signal-to-noise value for a plurality of analyte ions by dividing the abundance of the analyte ion by the noise value at a corresponding matrix ion; (f) assign the target ion as the analyte ion having the highest signal-to-noise value; and (g) assign a qualifier ion as the analyte ion with the next highest signal-to-noise value. Three qualifier ions may be selected. In one embodiment, the signal-to-noise value for a plurality of analyte ions is calculated by dividing the abundance of the analyte ion by the noise value at a corresponding matrix ion, and multiplying by a square root of the m/z of the analyte ion. In another embodiment, the computer-readable storage medium further comprises instructions executable by at least one processing device that, when executed, cause the processing device to process the reference spectrum to remove ions that are below a user-specified minimum abundance. The minimum abundance may be twenty-five percent. In another embodiment, the computer-readable storage medium further comprises instructions executable by at least one processing device that, when executed, cause the processing device to process the reference spectrum to remove ions that are below a user-specified mass minimum. The mass minimum abundance may be 45 amu.

### EXAMPLES

### Example 1

### Cocaine with Arachidonic Acid Interference

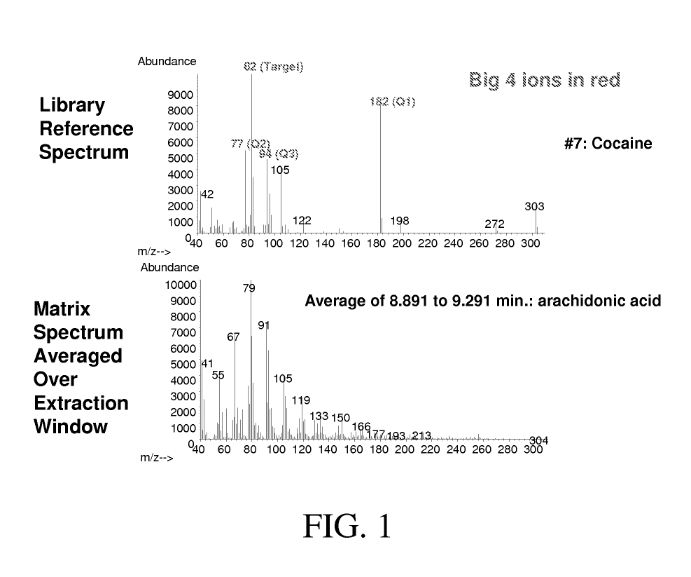

Blood extracts used in toxicology screening often contain fatty acids as interferences. One example interference is that of arachidonic acid with cocaine. FIG. 1 shows the reference spectrum of cocaine and the average spectrum over the cocaine extraction time range of arachidonic acid. The original four ions in the qdb are labeled. These ions were chosen because they were the largest four ions in the reference spectrum.

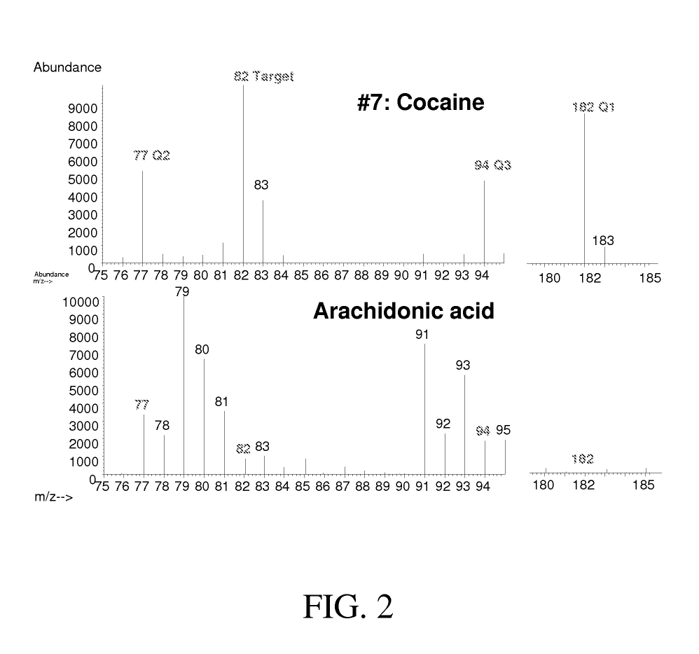

FIG. 2 shows expanded regions of these spectra to illustrate the interference problems. It is clear in FIG. 2 that three of the four original ions will have interference problems. Only ion 182 looks relatively clear of interference.

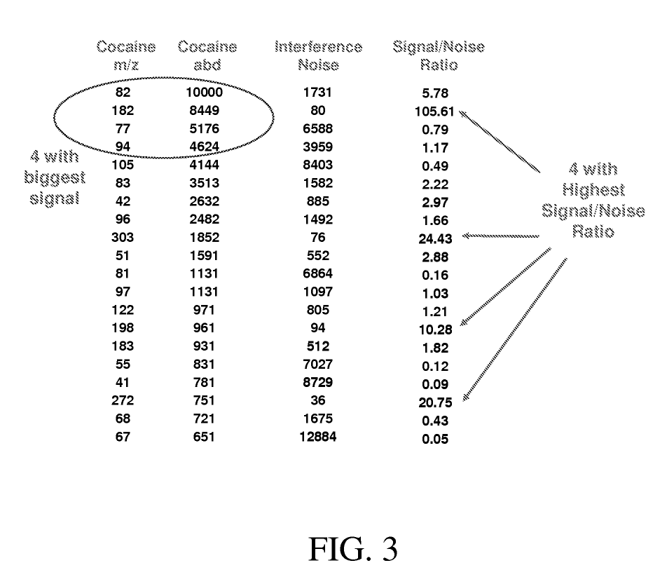

FIG. 3 shows the information in tabular form, wherein the top 20 ions are sorted by abd. Also shown in FIG. 3 is the interference noise measured over the extraction window at each of the cocaine ions. The rightmost column is the cocaine abundance divided by the interference noise (S/N value ratio). The rightmost column immediately shows the ions with the least interference (ie., highest S/N value ratio). It would be tempting to just take the four ions with the highest selectivity. However, ion 272 has an abundance of only 7.5%. While this would be a very good choice for this matrix, it may be less appropriate for cleaner matrices.

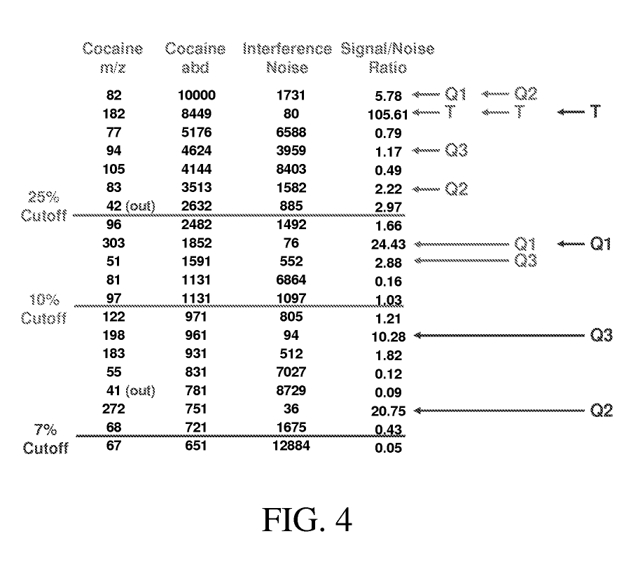

FIG. 4 shows the choice of cocaine ions affected by minimum ion abundance parameter. The line between masses 42 and 96 represents a minimum abundance cut off of 25%. Only ions above this line are eligible for optimization when the minimum abundance parameter is set to 25%. The target and qualifier ions chosen for the 25% optimization are also shown. Note that ion 42 is shown as “out” because in this case the minimum mass was set to 45 amu, making the ion ineligible for optimization.

If the minimum abundance cut off is dropped to 10%, then all of the ions above the line (with the exception of 42) are now eligible for optimization. In this case, the chosen target and qualifiers are shown. Note that with a lower abundance cut off it is possible to find more ions with better S/N values.

The line between masses 68 and 67 marks the 7% cutoff level. Note that two more ions with superior S/N value and selectivity are identified.

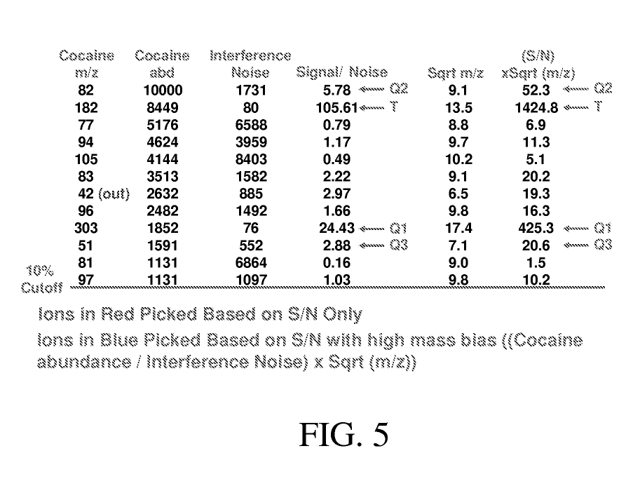

FIG. 5 shows what happens when a high mass bias is used. The fifth column from the left is the square root of the mass. With high mass bias turned on, the selectivity for each ion is multiplied by the square root of the mass. This new high mass biased S/N value is listed in column 6. The ions that would be chosen by S/N value only are shown and those chosen with the high mass bias are shown. In this particular example, the high mass bias did not change the ions selected because it did not change the ordering of the scores for the best four ions.

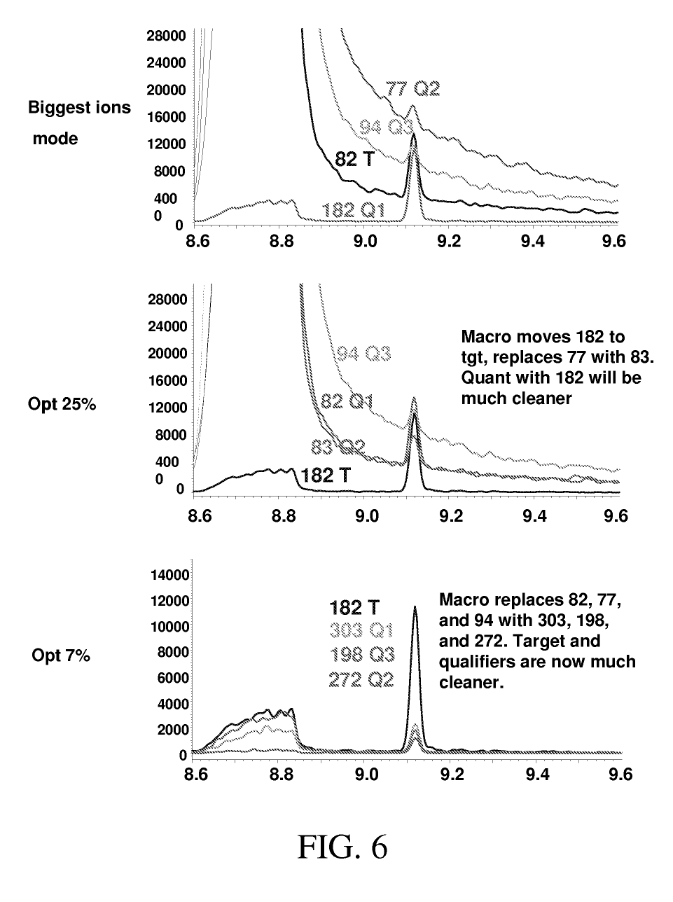

To demonstrate the effect of different minimum abundance cut off levels on chromatographic performance, a mixture containing 1 ng of cocaine and 2000 ng of arachidonic acid per microliter was injected. The results are shown in FIG. 6.

As the optimization minimum abundance cut off level is dropped from 25% to 7%, the ions chosen get smaller but have a higher S/N value and are more selective over the matrix. While 7% may be an unusually small abundance, this allows to test many more eligible ions to see if there are any that are cleaner. Note that with the 7% cutoff, the chosen ions are now much less affected by the interference and it is much easier for a data reviewer to see the target and qualifiers. It is also easier for the integrator to get the correct value for the area, because the baseline is flatter and the S/N value is higher.

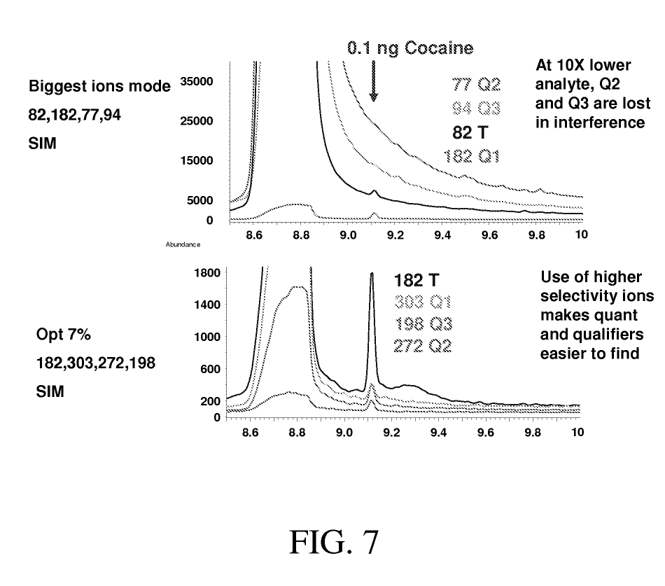

Choosing ions with the best S/N value and selectivity is important now that SIM/Scan is available. FIG. 7. shows a sample where the arachidonic acid is still at 2000 ng, but the cocaine is now tenfold lower at 0.1 ng. The analysis is run in SIM mode. Of course, the S/N value ratio over electronic noise is improved with SIM. However, in this case, the S/N value is limited by chemical noise from the arachidonic acid interference.

Using the biggest four ions shown in the top of FIG. 7, the cocaine response at Q2 and Q3 is lost in the chemical noise. The target (82) would also be somewhat challenging to integrate.

The ions chosen with the 7% optimation make it much easier to visualize and integrate the peak. Of course, if the large arachidonic peak were absent, the S/N value of other ions would be better.

### Example 2

### Optimizing Heroin Against Column Bleed and Background

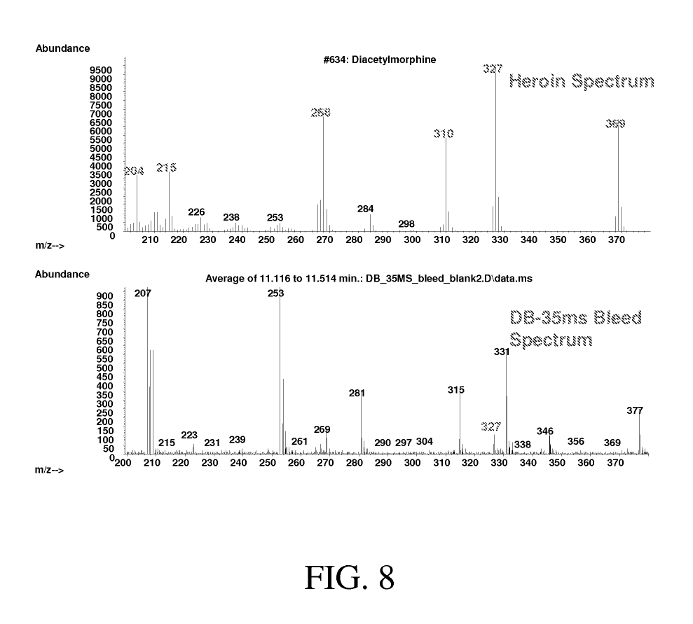

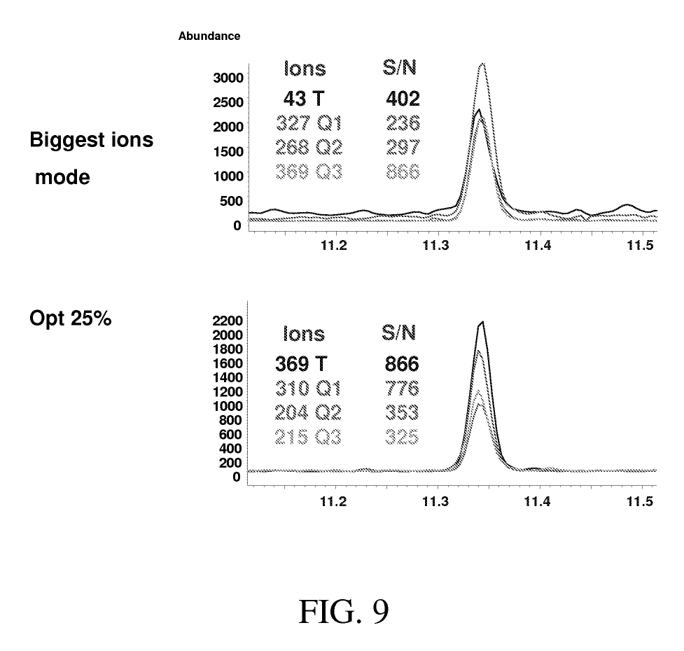

The top of FIG. 8 shows the reference spectrum for heroin. The bottom is the average spectrum over the heroin extraction window of the background and bleed from a blank run. The column phase is DB-35 ms. The spectral interferences from the bleed ions and background ions don't appear to be too severe. The process was optimized against the bleed with a 25% minimum abundance cutoff and m/z 45 mass cutoff. The results are show in FIG. 9. The optimization replaced three of the original four ions improved the S/N value.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A method for selecting a target ion and a plurality of qualifier ions for calibration of an analyte in an MS test, the method comprising:
(a) obtaining a reference spectrum for the analyte;
(b) identifying an extraction time window for the reference spectrum;
(c) extracting a matrix spectrum over the extraction time window;
(d) measuring a noise value in a plurality of matrix ions;
(e) calculating a signal-to-noise value for a plurality of analyte ions by dividing the abundance of the analyte ion by the noise value at a corresponding matrix ion;
(f) assigning the target ion as the analyte ion having the highest signal-to-noise value; and
(g) assigning a qualifier ion as the analyte ion with the next highest signal-to-noise value.

2. The method of claim 1, further comprising:
(h) repeating step (g) until three qualifier ions are selected.

3. The method of claim 1, wherein step (e) further comprises calculating a signal-to-noise value for a plurality of analyte ions by dividing the abundance of the analyte ion by the noise value at a corresponding matrix ion, and multiplying by a square root of the m/z of the analyte ion.

4. The method of claim 1, wherein step (a) further comprises:
processing the reference spectrum to remove ions that are below a user-specified minimum abundance.

5. The method of claim 4, wherein the minimum abundance is twenty-five percent.

6. The method of claim 1, wherein step (a) further comprises:
processing the reference spectrum to remove ions that are below a user-specified mass minimum.

7. The method of claim 6, wherein the mass minimum abundance is 45 amu.

8. A computer-readable storage medium for selecting a target ion and a plurality of qualifier ions for calibration of an analyte in an MS test, comprising:
instructions executable by at least one processing device that, when executed, cause the processing device to
(a) obtain a reference spectrum for the analyte;
(b) identify an extraction time window for the reference spectrum;
(c) extract a matrix spectrum over the extraction time window;
(d) measure a noise value in a plurality of matrix ions;
(e) calculate a signal-to-noise value for a plurality of analyte ions by dividing the abundance of the analyte ion by the noise value at a corresponding matrix ion;
(f) assign the target ion as the analyte ion having the highest signal-to-noise value; and
(g) assign a qualifier ion as the analyte ion with the next highest signal-to-noise value.

9. The computer-readable storage medium of claim 8, wherein three qualifier ions are selected.

10. The computer-readable storage medium of claim 8, wherein the signal-to-noise value for a plurality of analyte ions is calculated by dividing the abundance of the analyte ion by the noise value at a corresponding matrix ion, and multiplying by a square root of the m/z of the analyte ion.

11. The computer-readable storage medium of claim 8, further comprising:
instructions executable by at least one processing device that, when executed, cause the processing device to process the reference spectrum to remove ions that are below a user-specified minimum abundance.

12. The computer-readable storage medium of claim 11, wherein the minimum abundance is twenty-five percent.

13. The computer-readable storage medium of claim 8, further comprising:
instructions executable by at least one processing device that, when executed, cause the processing device to process the reference spectrum to remove ions that are below a user-specified mass minimum.

14. The computer-readable storage medium of claim 13, wherein the mass minimum abundance is 45 amu.

15. A mass spectrometry method comprising:
selecting a target ion and three qualifier ions, for calibration of an analyte in an MS test, by
(a) obtaining a reference spectrum for the analyte;
(b) identifying an extraction time window for the reference spectrum;
(c) extracting a matrix spectrum over the extraction time window;
(d) measuring a noise value in a plurality of matrix ions;
(e) calculating a signal-to-noise value for a plurality of analyte ions by dividing the abundance of the analyte ion by the noise value at a corresponding matrix ion;
(f) assigning the target ion as the analyte ion having the highest signal-to-noise value; and
(g) assigning three qualifier ions as the analyte ions with the next three highest signal-to-noise values.

16. The method of claim 15, wherein step (e) further comprises calculating a signal-to-noise value for a plurality of analyte ions by dividing the abundance of the analyte ion by the noise value at a corresponding matrix ion, and multiplying by a square root of the abundance of the matrix ion.

17. The method of claim 15, wherein step (a) further comprises:
processing the reference spectrum to remove ions that are below a user-specified minimum abundance.

18. The method of claim 17, wherein the minimum abundance is twenty-five percent.

19. The method of claim 15, wherein step (a) further comprises:
processing the reference spectrum to remove ions that are below a user-specified mass minimum.

20. The method of claim 19, wherein the mass minimum abundance is 45 amu.
